(19) United States
(12) Patent Application Publication
(10) Pub. No.: US 2010/0242667 A1
(43) Pub. Date: Sep. 30, 2010

(54) BRAKE HANDLE ADAPTER FOR TRUCKS AND BUSSES

(76) Inventors: Peggy Kolowinski, Algona, WA (US); Shirleen Walker, Auburn, WA (US)

Correspondence Address: Larry E Severin, Esq, 3581 Teaberry Circle, Seal Beach, CA, 90740, US

(21) Appl. No.: 12/750,308

(22) Filed: Mar. 30, 2010

Related U.S. Application Data
(60) Provisional application No. 61/164,555, filed on Mar. 30, 2009.

(51) Int. Cl. G05G 1/54; G05G 1/04

(52) U.S. Cl. 74/544

(57) ABSTRACT

A brake handle adapter for trucks and busses having a dashboard and a shaft with a knob includes: a hand plate; a lifting portion attached to the hand plate, adapted to press the knob away from the dashboard; a depressor portion attached to the lifting portion, adapted to press upon the dashboard to provide leverage; and a resting lever attached to the handle, adapted to rest upon the dashboard when the handle is not being operated When the user pulls on the hand plate, the lifting portion engages with and presses upon the knob so as to pull the shaft away from the dashboard. A resting lever adjacent the hand plate rests upon the dashboard. The device helps absorb the kick from operating the brake, to help prevent pain.

### RELATED APPLICATIONS

This application claims the benefit of the filing date of U.S. Patent Application No. 61/164,555, filed Mar. 30, 2009, which is incorporated herein by reference in its entirety.

### BACKGROUND OF THE INVENTION

The present invention generally relates to brakes and, more specifically, to a brake for busses.

Current air brakes for busses and trucks are often controlled by a shaft with a knob, possibly rectangular shape, diamond shape, or another shape. The knob is held to the shaft with a removable pin. The driver pulls on the knob to pull the shaft away from the dashboard, thereby affecting operation of the brake.

Pulling of the air brake handle may cause pressure and pain. When the driver pulls the knob or handle of the air brake located on the dash, it may have a kick to it that can cause pain to go through the driver's hand, elbow, and up the arm, and even to the shoulder. Users must pull the handle, possibly hurting their hands.

As can be seen, there is a need for a brake for busses and trucks.

### SUMMARY OF THE INVENTION

In one aspect of the present invention, a device utilizing a shaft with a knob includes: a hand plate; a lifting portion attached to the hand plate; and a depressor portion attached to the lifting portion; wherein when the user pulls on the hand plate, the depressor portion presses away from the lifting portion and the lifting portion presses on the knob thereby pulling upon the shaft.

In another aspect of the present invention, a handle for a vehicle having a dashboard and a shaft with a knob includes: a hand plate; a lifting portion attached to the hand plate, adapted to press the knob away from the dashboard; a depressor portion attached to the lifting portion, adapted to press upon the dashboard to provide leverage; and a resting lever attached to the handle, adapted to rest upon the dashboard when the handle is not being operated; wherein when the user pulls on the hand plate, the lifting portion engages with and presses upon the knob so as to pull the shaft away from the dashboard.

In yet another aspect of the present invention, a method of urging a shaft with a knob away from a dashboard includes: pulling a hand plate away from the dashboard; utilizing a lifting portion attached to the hand plate to urge the knob away from the dashboard, thereby pulling upon the shaft; and utilizing a depressor portion attached to the lifting portion to press upon the dashboard, thereby providing leverage for the lifting portion.

### BRIEF DESCRIPTION OF THE DRAWINGS

FIG. 1 depicts vehicles with brakes; and

FIG. 2 depicts an embodiment of the present invention

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps may be performed in that order.

Broadly, an embodiment of the present invention generally relates to a unit that goes on a truck, buss, vehicle, pick-up, car, or other vehicle having a hand-operated pull device that may be pulled by the operator in order to operate the vehicle. An embodiment of the present device may include an anti-terrorist, anti-theft, security brake or other device. An embodiment for busses may be pulled at every bus stop. The unit may eliminate the pressure and pain to the driver when pulling the brake.

An embodiment of the present invention may include a device that goes behind the knob and has the freedom to absorb the shock of the air pressured brake, so that it eliminates or reduces the effect of the kick. In return that use may avoid pain to the hand, elbow or shoulder.

An embodiment may include two metal bars joined together, having a small downward curve. The two parts may separate and curve around the shaft of the existing brake unit, past the brake unit, and coming back together. Three metal bars may be included. One bar bends downward to rest on the dash, and the two others curve upwards to form a handle. The handle is what one may grab to activate the air brake. The unit may be loose around the brake handle so that when one uses the handle, the handle does not induce the pain of pulling that might be caused by an existing solid unit.

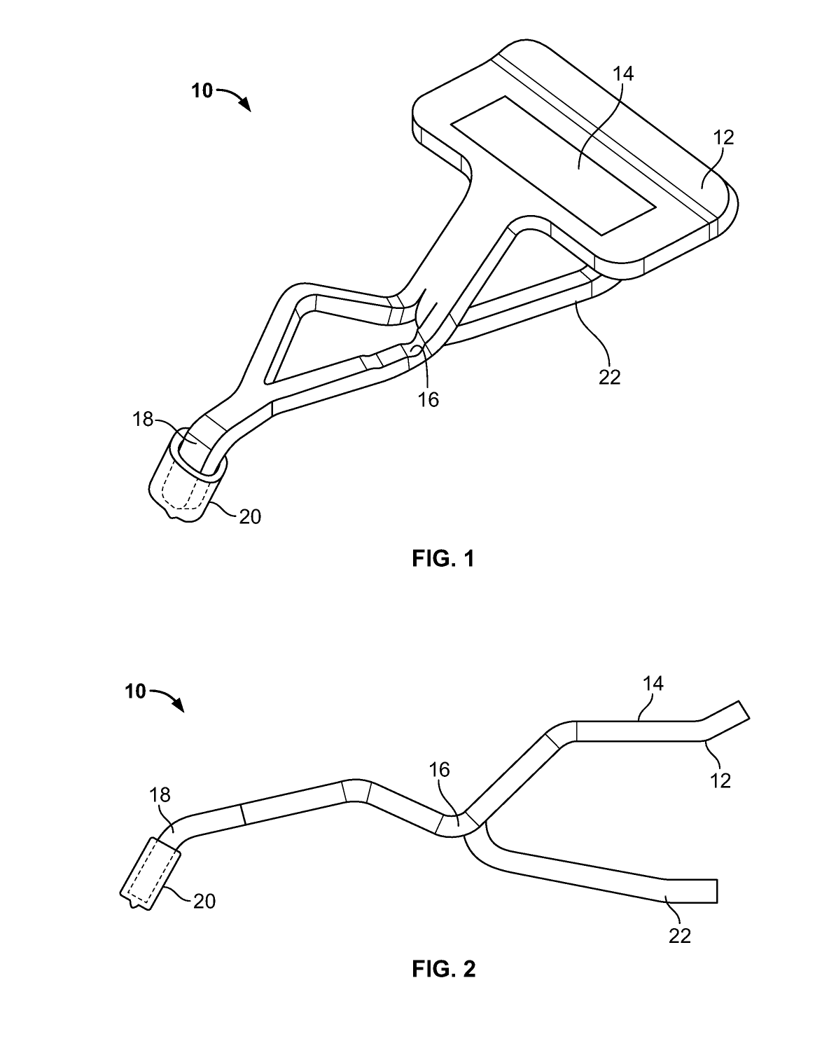

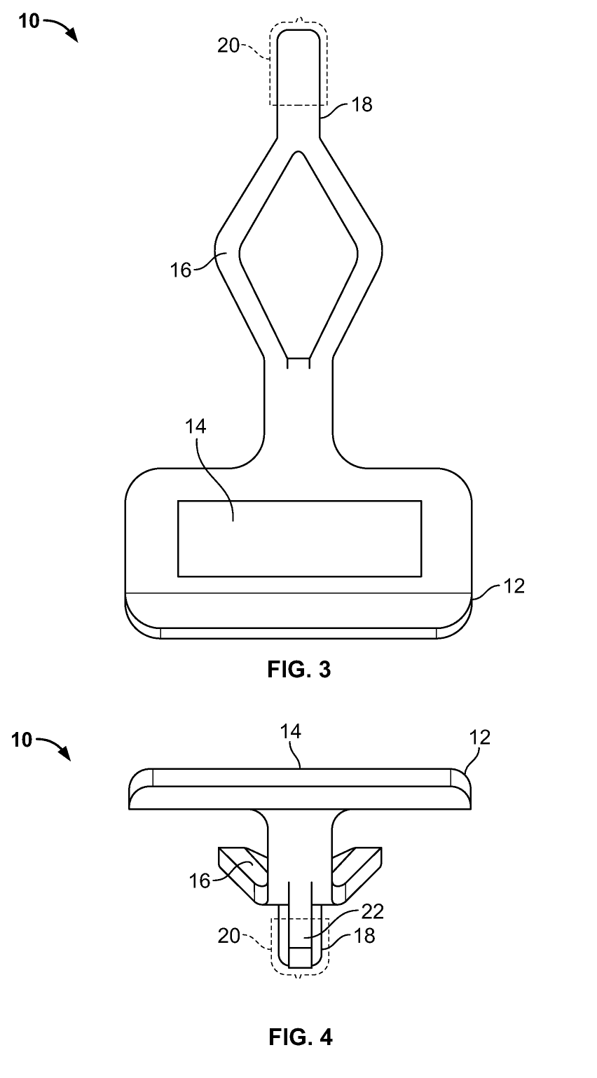

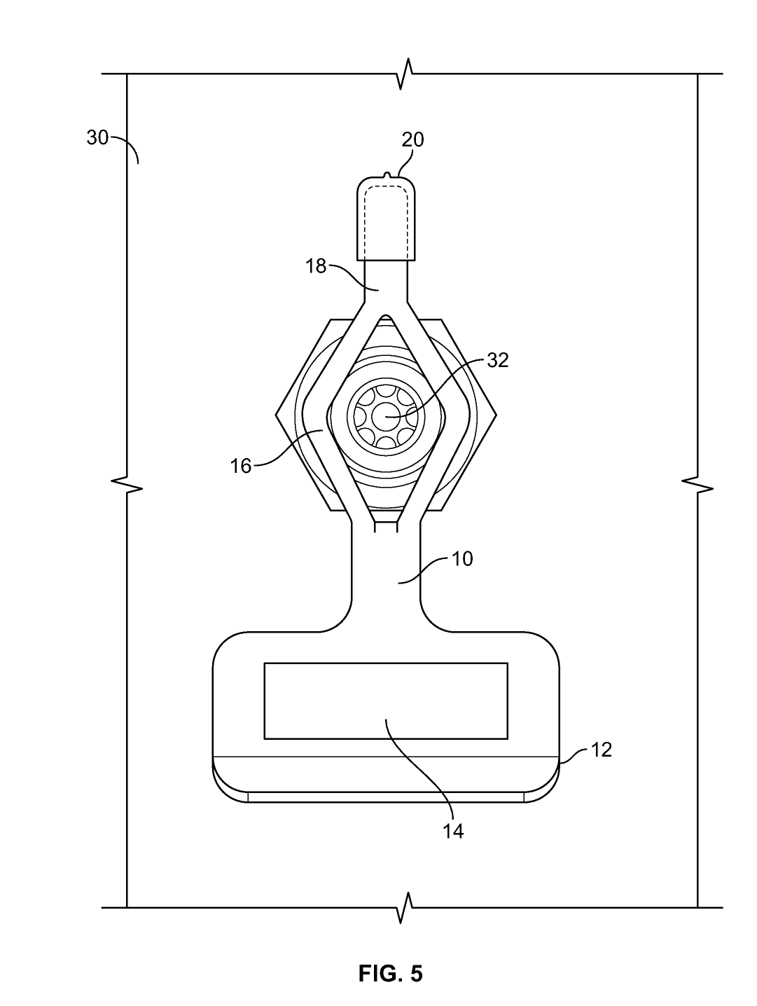

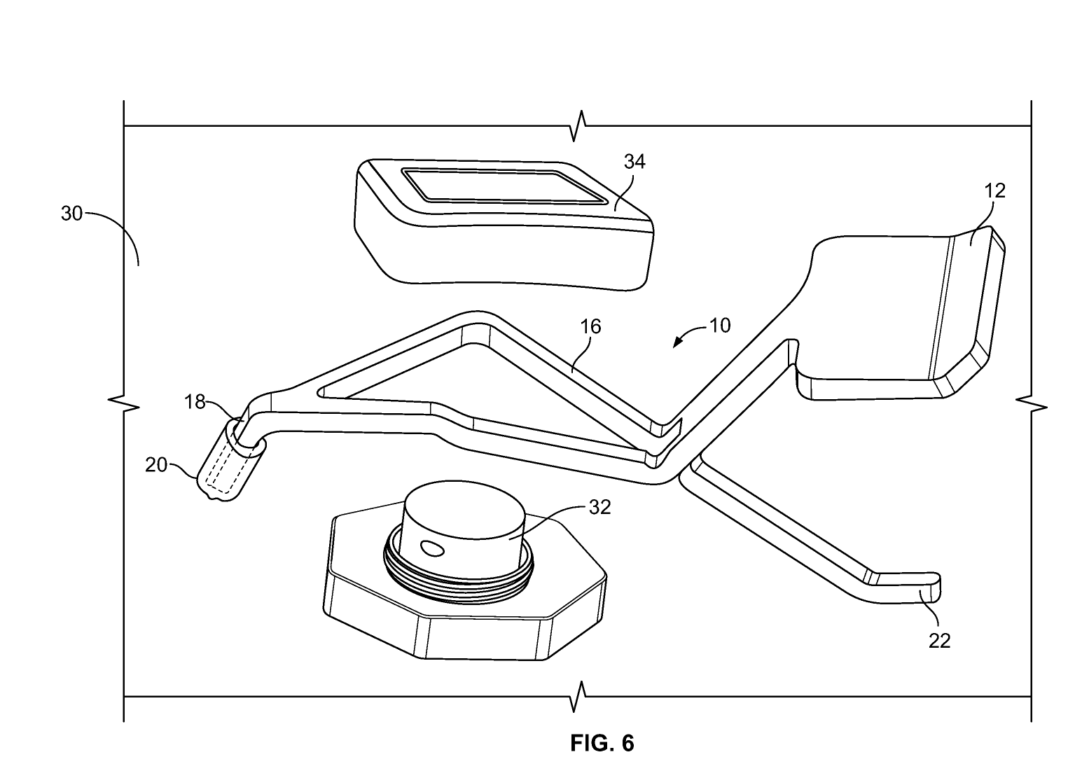

As depicted in FIGS. 1-4, an embodiment of a handle 10 may include a hand plate 12, with designator 14 or label. A lifting portion 16 may effectuate the air brake when the plate 12 is lifted or pulled upon by the user. When the hand plate 12 is pulled away from a dashboard of the truck or bus with the user's hand, a depressor element 18 provides a pivot point for leverage, reducing pressure and pain in the user's hand. Depressor element 18 may have a cover 20 or other rubberized coating or other material to engage with and press upon the dashboard. A resting lever 22 may support the device 10 against the dashboard when the device is not being pulled by the user. Designator 14 may include, for example, instructions, a logo, an advertisement, or other indicia.

As depicted in FIGS. 5-6. The force from the depressor element 18, through the rubberized cover 20, may press against a dashboard 30 of a truck or bus or other vehicle, to help provide leverage. Brake shaft 32 extends away from dashboard 30, and has a brake knob 34, which may be rectangular shaped. When the hand plate 12 is lifted, the sides of lifter 16 press upon the underside of knob 34, thereby pulling on the brake shaft 32, urging the shaft and knob away from the dashboard to affect control of the brake.

To install an embodiment, brake knob 34 may be separated from brake shaft 32, possibly by removing a pin. One may install the device 10 around an existing brake handle. The device will hang down, and it is needed, one may just grab the unit and pull. This may activate the brake without causing any kick, which otherwise causes pain to the hand and arm or shoulder.

With application of an embodiment of the invention, users might be able to affect controls on vehicles, such as brakes for trucks and busses. The user may be able to affect the brake or control with reduced stress, pain, or pressure to the hand of the user, because the device may provide a leverage that helps effect the brake/control. An effective, efficient leverage may enhance the effective strength of the user's available hand strength and/or pressure.

An embodiment may include a device for a bus having a knob, a dash and a brake. The device may include a unit positioned behind the knob on the bus, the unit having freedom to absorb a shock of the brake; a first metal bar, having a downward curve; a second metal bar, having a downward curve. The first and second metal bars may have a separation and curve around a shaft of the brake. The downward curves of both bars may bend downward to rest on the dash, the two bars curving upward to form a handle. An embodiment may be made of metal that may separate to conform around the handle of a brake, which may include a handle for the driver to grab. To make an embodiment, a machinist could cast a form and then pour in metal to form this unit. Alternatively, one may machine press metal to form the device. One may also weld two metal rods together and then separate them to shape this form.

I claim:

1. A device utilizing a shaft with a knob, comprising:
a hand plate;
a lifting portion attached to the hand plate; and
a depressor portion attached to the lifting portion;
wherein when the user pulls on the hand plate, the depressor portion presses away from the lifting portion and the lifting portion presses on the knob thereby pulling upon the shaft.

2. The device of claim 1, wherein the shaft and knob control a vehicle having a dashboard, and when the user pulls on the hand plate, the depressor portion presses upon the dashboard thereby providing leverage for the lifting portion to press upon the knob.

3. The device of claim 1, wherein the lifting portion includes an aperture with sides adapted to engage with the knob and press the knob away from the depressor portion.

4. The device of claim 1, wherein the lifting portion includes a generally diamond-shaped aperture adapted to engage with the knob when the hand plate is pulled.

5. The device of claim 1, further comprising:
a cover on the depressor portion, adapted to engage with and press upon the dashboard of a vehicle.

6. The device of claim 1, further comprising:
a designator on the hand plate adapted to be viewed a user of the device.

7. The device of claim 1, further comprising:
a resting lever adjacent the hand plate, adapted to rest upon the dashboard of a vehicle.

8. The device of claim 7, wherein the depressor portion includes a first curved metal bar and the resting lever includes a second curved metal bar.

9. The device of claim 1, wherein the shaft and knob operate the brake of a vehicle that provides a kick when operated, and the device is adapted to be positioned around the shaft and behind the knob so that the device helps absorb the kick.

10. A handle for a vehicle having a dashboard and a shaft with a knob, the handle comprising:
a hand plate;
a lifting portion attached to the hand plate, adapted to press the knob away from the dashboard;
a depressor portion attached to the lifting portion, adapted to press upon the dashboard to provide leverage; and
a resting lever attached to the handle, adapted to rest upon the dashboard when the handle is not being operated;
wherein when the user pulls on the hand plate, the lifting portion engages with and presses upon the knob so as to pull the shaft away from the dashboard.

11. The handle of claim 10, wherein the shaft and knob control a brake of the vehicle that provides a kick when operated, and the device is adapted to be positioned around the shaft and behind the knob so that the device helps absorb the kick.

12. The handle of claim 10, wherein the lifting portion includes an aperture with sides adapted to engage with the knob and press the knob away from the dashboard, thereby pulling upon the shaft.

13. The handle of claim 10, further comprising:
a designator on the hand plate providing indicia to be viewed.

14. A method of urging a shaft with a knob away from a dashboard, the method comprising:
pulling a hand plate away from the dashboard;
utilizing a lifting portion attached to the hand plate to urge the knob away from the dashboard, thereby pulling upon the shaft; and
utilizing a depressor portion attached to the lifting portion to press upon the dashboard, thereby providing leverage for the lifting portion.

15. The method of claim 14, wherein the dashboard is the dashboard of a vehicle, and the shaft and knob control a brake of the vehicle.

16. The method of claim 14, further comprising:
utilizing a resting lever to support the hand plate and lifting portion against the dashboard.

17. The method of claim 14, further comprising:
providing a handle that includes the hand plate, the lifting portion, the depressor portion, and a resting lever.

18. The method of claim 14, wherein the shaft and knob operate the brake of a vehicle that provides a kick when operated, the lifting portion is adapted to be positioned around the shaft, and the depressor portion is adapted to be positioned against the dashboard, thereby providing a device to help absorb the kick.

19. The method of claim 14, further comprising:
covering the depressor portion with a material adapted to engage with and press upon the dashboard.
